(19) United States
(12) Patent Application Publication
(10) Pub. No.: US 2017/0002938 A1
(43) Pub. Date: Jan. 5, 2017

(54) Valve Having Non-Round Closure Member

(71) Applicant: Victaulic Company, Easton, PA (US)

(72) Inventor: Steven Wortmann, Slatington, PA (US)

(21) Appl. No.: 14/790,656

(22) Filed: Jul. 2, 2015

(51) Int. Cl. F16K 15/03; F16K 1/20

(52) U.S. Cl. CPC F16K 15/03; F16K 1/20

(57) ABSTRACT

A valve has a single piece housing defining an inlet, an outlet and a chamber therebetween. A non-round valve closing member engages a non-round seat within the chamber.

### FIELD OF THE INVENTION

This invention relates to valves, for example, check valves, control valves and pressure relief valves.

### BACKGROUND

Full port check valves, wherein the valve seat has substantially the same cross sectional area as the inlet and the outlet ports, are advantageous because they reduce fluid flow through the valve less than valves wherein the seat has a smaller cross sectional area than the inlet and outlet ports. However, full port check valves tend to be more complicated, as their housings are usually assembled from multiple pieces. Multiple piece housings are needed because check valves use pivoting clappers as their valve closure member, and clappers use face seals which seal against the valve seat. To sealingly engage the valve seat, face seals must match the size and shape of the valve seat. If the valve seat is equal in diameter (and hence in area) to the inlet and outlet ports it will not be possible to insert the clapper into the valve housing through the inlet or the outlet because a round clapper cannot pass through a round port of the same diameter. Hence the need for a housing that comes apart to permit installation of a clapper that is matched in size to the full port valve seat.

Advantages would be realized if a check valve (as well as other types of valves, such as control valves and pressure relief valves) were made having a single piece housing, made for example, by casting, machining or molding, so that it needed no assembly, such as bolting, brazing or welding of various parts to one another. However, prior art valves having a single piece housing have a clapper that is limited in size so that it may pass through the valve inlet or outlet for installation within the valve. The smaller clapper limits the cross sectional area of the valve seat, which must be smaller than the cross sectional area of the inlet and the outlet, resulting in greater resistance to fluid flow. There is clearly an opportunity to improve both the construction and performance of valves by developing a valve that uses a single piece housing yet does not suffer the known disadvantages of prior art valves.

### SUMMARY

The invention concerns a valve. In one example embodiment the valve comprises a single piece housing defining an inlet having an inlet inner diameter, an outlet having an outlet inner diameter, and a chamber positioned between the inlet and the outlet. A valve seat is positioned within the chamber between the inlet and the outlet. The valve seat defines an opening having a non-round cross sectional shape. A valve closing member is mounted within the chamber. The valve closing member has a non-round cross sectional shape. The valve closing member is movable between a closed position sealingly engaging the valve seat, and an open position out of engagement with the valve seat.

In this example the valve closing member has a major dimension and a minor dimension less than the major dimension. The major dimension is greater than or substantially equal to one of the inlet inner diameter and the outlet inner diameter. The minor dimension is smaller than one of the inlet inner diameter and the outlet inner diameter to permit the valve closing member to be inserted into the chamber through one of the inlet and the outlet.

In a particular example embodiment the valve closing member is pivotably mounted within the chamber. By way of example the valve closing member has a lozenge shape. In a further example the opening of the valve seat has a lozenge shape. In an example embodiment the major dimension of the valve closing member is greater than the inlet inner diameter. In a further example the major dimension of the valve closing member is greater than the outlet inner diameter. Also by way of example, the minor dimension of the valve closing member is smaller than the inlet inner diameter. In another example the minor dimension of the valve closing member is smaller than the outlet inner diameter. By way of example, at least one of the inlet and the outlet has a round cross sectional shape. In a specific example embodiment the valve comprises a check valve.

Another example embodiment of a valve according to the invention comprises a single piece housing defining an inlet having an inlet inner diameter, an outlet having an outlet inner diameter, and a chamber positioned between the inlet and the outlet. A valve seat is positioned within the chamber between the inlet and the outlet. The valve seat defines an opening having a non-round cross sectional shape. In this example only a single valve closing member is mounted within the chamber. The single valve closing member has a non-round cross sectional shape.

By way of further example, the single valve closing member is movable between a closed position sealingly engaging the valve seat and an open position out of engagement with the valve seat. In another example the single valve closing member has a major dimension and a minor dimension less than the major dimension, the major dimension being greater than one of the inlet inner diameter and the outlet inner diameter, the minor dimension being smaller than one of the inlet inner diameter and the outlet inner diameter to permit the single valve closing member to be inserted into the chamber through one of the inlet and the outlet.

In a particular example embodiment the single valve closing member is pivotably mounted within the chamber. Also by way of example the single valve closing member has a lozenge shape. Additionally by way of example, the opening of the valve seat has a lozenge shape.

In one example embodiment, the inlet has a conical inner surface defining a minimum inlet inner diameter. In a further example, the outlet has a conical inner surface defining a minimum outlet inner diameter.

By way of example, the major dimension of the single valve closing member is greater than the minimum inlet inner diameter. Further by way of example, the major dimension of the single valve closing member is greater than the minimum outlet inner diameter. In another example embodiment, the minor dimension of the single valve closing member is smaller than the minimum inlet inner diameter. Further by way of example, the minor dimension of the single valve closing member is smaller than the minimum outlet inner diameter.

In a particular example embodiment, the valve comprises a check valve.

The invention also encompasses a method of assembling a valve closing member into a valve having a single piece housing defining an inlet, an outlet and a chamber therebetween, a valve seat being positioned within the chamber. One example method comprises:
inserting the valve closing member through one of the inlet and the outlet into the chamber;
mounting the valve closing member within the chamber for movement between a closed position sealingly engaging the valve seat, and an open position out of engagement with the valve seat.

A particular example method comprises inserting the valve closing member through the outlet into the chamber. An example method further comprises pivotably mounting the valve closing member within the chamber.

### BRIEF DESCRIPTION OF THE DRAWINGS

FIG. 1 is an isometric view of an example valve according to the invention;

FIG. 2 is an isometric longitudinal sectional view of the example valve shown in FIG. 1;

FIG. 3 is a longitudinal sectional view of the example valve shown in FIG. 1; and

FIG. 4 is a plan view of an example valve closing member according to the invention used with the example valve shown in FIG. 1.

### DETAILED DESCRIPTION

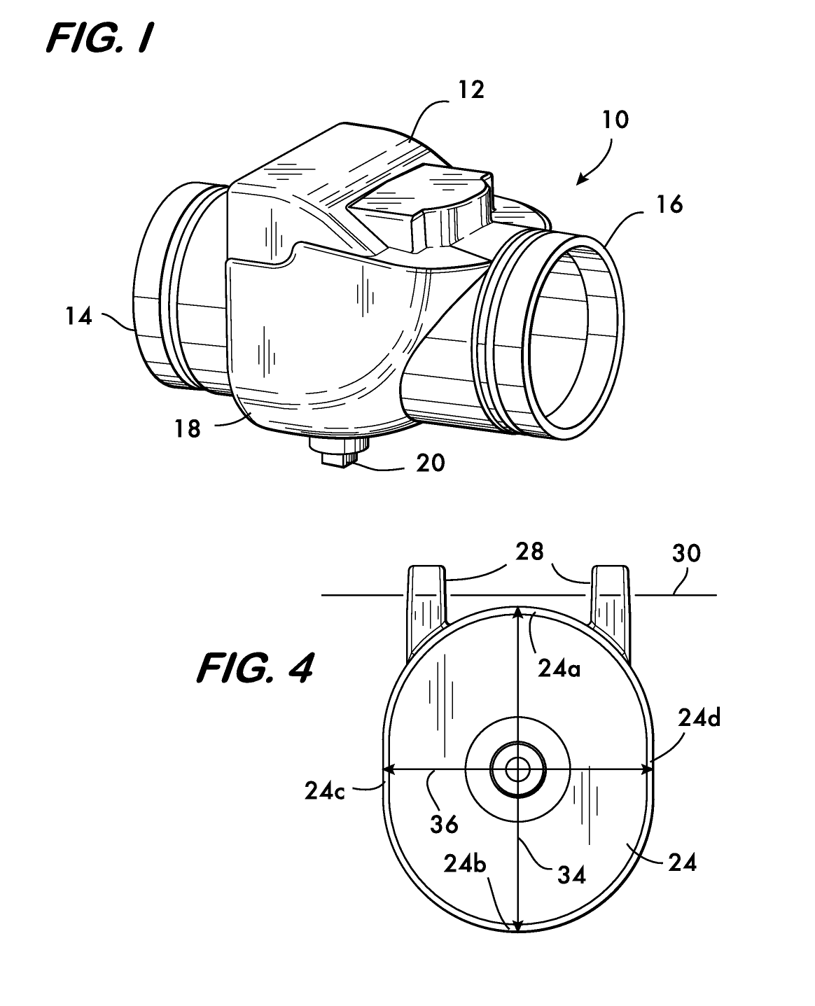

FIG. 1 shows an isometric view of a valve, in this example a check valve 10 according to the invention. Although a check valve is illustrated, it is understood that other types of valves, such as control valves and pressure relief valves are also encompassed by the invention. Valve 10 comprises a single piece housing 12 defining an inlet 14, an outlet 16 and a chamber 18 positioned between the inlet and the outlet. The inlet, outlet and chamber of housing 12 comprise a single piece, i.e., they are cast, molded, machined or otherwise formed together of one piece, needing no assembly, having no major piece parts to be joined by fasteners, brazing or welding. While there may be minor separate components such as a drain plug 20 as well as internal components (described below), the housing itself (the inlet, outlet and chamber) is integrally formed as a unitary structure.

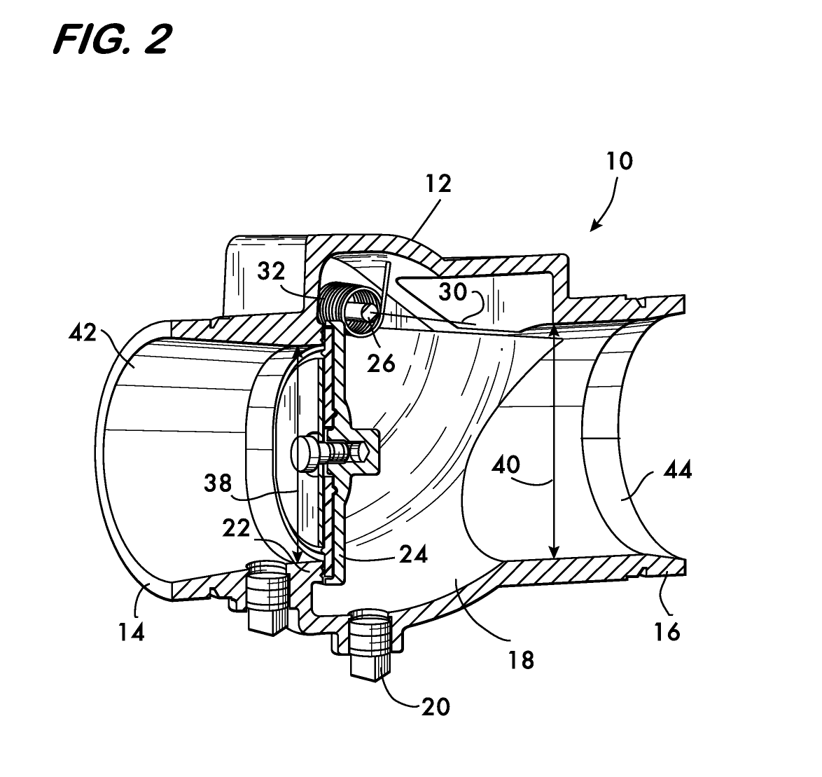

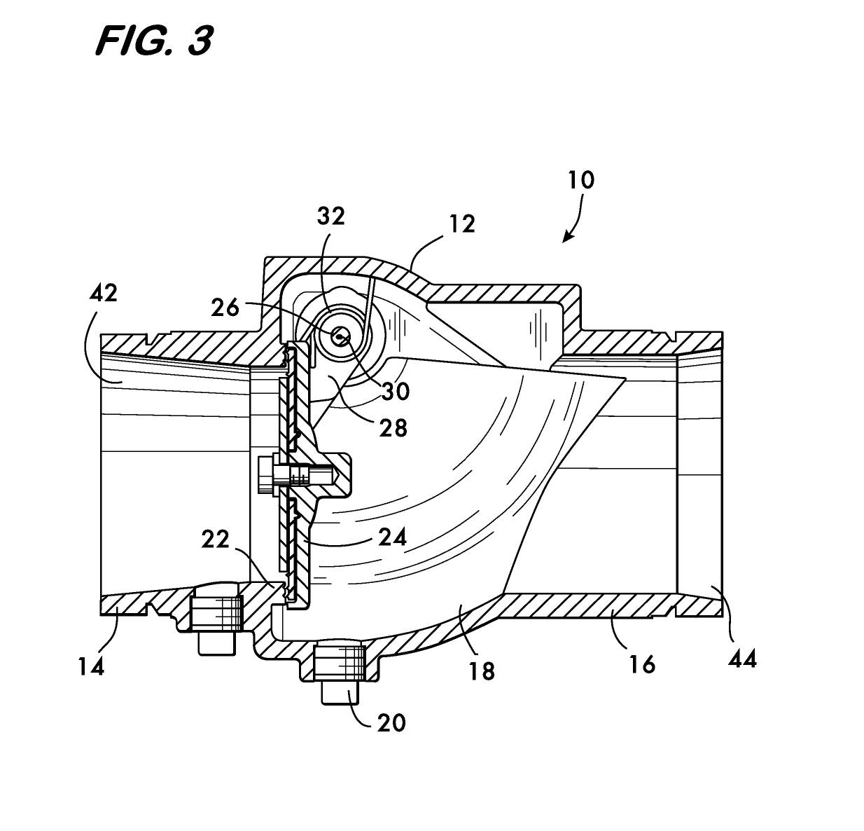

As shown in FIGS. 2 and 3, valve 10 comprises a valve seat 22. Valve seat 22 is a face sealing seat and is positioned with in the chamber 18, in this example adjacent to the inlet 14. A valve closing member 24 is mounted within the chamber 18. In this example the valve closing member is a clapper mounted on an axle 26 via lugs 28 for pivoting motion about an axis 30 defined by the axle 26. A spring 32 biases the valve closing member 24 into engagement with the valve seat 22, the closing member being pivotably movable between a closed position sealingly engaging the valve seat (shown) and an open position out of engagement with the valve seat.

Both the valve seat 22 and the valve closing member 24 have non round cross sectional shapes. The shapes are matched to one another to permit sealing engagement between them when the valve closing member is in the closed position. As shown in FIG. 4, the example valve closing member 24 has a “lozenge” cross sectional shape wherein lozenge is defined as having semi-circular portions 24a and 24b joined by straight portions 24c and 24d. Due to this lozenge shape the valve closing member 24 has a major dimension 34, measured between the semi-circular portions 24a and 24b, and a minor dimension 36, measured between the straight portions 24c and 24d. While a lozenge shape is depicted in the example valve, the non-round shape of the valve closing member 24 (and consequently the valve seat 22) could have other non-round shapes, such as ellipsoidal, rhomboidal, rectangular and the like.

As shown in FIGS. 2 and 3, the major and minor dimensions of the valve closing member 24 are related to one or both of the inlet inner diameter 38 and the outlet inner diameter 40. (It is practical to define the inlet inner diameter 38 and the outlet inner diameter 40 to be the minimum inner diameters of the inlet and outlet. In the example valve illustrated, both the inlet and outlet have a conical inner surface.) The relationship is such that the major dimension 34 is greater than the minor dimension 36, and the major dimension 34 is also substantially equal to or greater than either one or both of the inlet inner diameter 38 and the outlet inner diameter 40. The minor dimension 36 is further sized to permit the valve closing member 24 to be inserted into chamber 18 through either or both the inlet 14 and the outlet 16, and the minor dimension 36 is thus smaller than the inlet inner diameter 38, or the outlet inner diameter 40, or both.

The dimensional relations between the inlet and outlet inner diameters 38 and 40 and the minor dimension 36 of the valve closing member 24 permit the use of a single piece housing 12 because installation of the valve closing member 24 into the chamber 18 may be effected by inserting the valve closing member into the chamber through either the inlet 14 or the outlet 16. Once positioned within the chamber 18 the valve closing member 24 may be manipulated to mount it on axle 26 for pivoting motion relative to the valve seat 22. Once assembly of the valve closing member 24 is complete (along with other minor components such as the drain plug 20) the valve is 10 is ready for installation in a piping network.

The use of the non-round valve closing member 24 in combination with the single piece housing 12 provides at least two advantages for valves such as check valves, control valves and pressure relief valves. First, it permits a simpler valve design with fewer piece parts; second, it permits the use of a valve seat having an opening larger in cross sectional area than would otherwise be permitted with a round valve closing member. It is thus expected that valves according to the invention will achieve lower head loss than similarly sized prior art valves, thereby requiring smaller pumps for a more efficient and economical fluid transport system.

What is claimed is:

1. A valve, comprising:
a single piece housing defining an inlet having an inlet inner diameter, an outlet having an outlet inner diameter, and a chamber positioned between said inlet and said outlet;
a valve seat positioned within said chamber between said inlet and said outlet, said valve seat defining an opening having a non-round cross sectional shape;
a valve closing member mounted within said chamber, said valve closing member having a non-round cross sectional shape, said valve closing member being movable between a closed position sealingly engaging said valve seat and an open position out of engagement with said valve seat; wherein
said valve closing member has a major dimension and a minor dimension less than said major dimension, said major dimension being greater than or substantially equal to one of said inlet inner diameter and said outlet inner diameter, said minor dimension being smaller than one of said inlet inner diameter and said outlet inner diameter to permit said valve closing member to be inserted into said chamber through one of said inlet and said outlet.

2. The valve according to claim 1, wherein said valve closing member is pivotably mounted within said chamber.

3. The valve according to claim 1, wherein said valve closing member has a lozenge shape.

4. The valve according to claim 3, wherein said opening of said valve seat has a lozenge shape.

5. The valve according to claim 1, wherein said major dimension of said valve closing member is greater than said inlet inner diameter.

6. The valve according to claim 1, wherein said major dimension of said valve closing member is greater than said outlet inner diameter.

7. The valve according to claim 1, wherein said minor dimension of said valve closing member is smaller than said inlet inner diameter.

8. The valve according to claim 1, wherein said minor dimension of said valve closing member is smaller than said outlet inner diameter.

9. The valve according to claim 1, wherein said valve comprises a check valve.

10. The valve according to claim 1, wherein at least one of said inlet and said outlet has a round cross sectional shape.

11. A valve, comprising:
a single piece housing defining an inlet having an inlet inner diameter, an outlet having an outlet inner diameter, and a chamber positioned between said inlet and said outlet;
a valve seat positioned within said chamber between said inlet and said outlet, said valve seat defining an opening having a non-round cross sectional shape;
only a single valve closing member mounted within said chamber, said single valve closing member having a non-round cross sectional shape.

12. The valve according to claim 11, wherein said single valve closing member is movable between a closed position sealingly engaging said valve seat and an open position out of engagement with said valve seat.

13. The valve according to claim 11, wherein said single valve closing member has a major dimension and a minor dimension less than said major dimension, said major dimension being greater than one of said inlet inner diameter and said outlet inner diameter, said minor dimension being smaller than one of said inlet inner diameter and said outlet inner diameter to permit said single valve closing member to be inserted into said chamber through one of said inlet and said outlet.

14. The valve according to claim 11, wherein said single valve closing member is pivotably mounted within said chamber.

15. The valve according to claim 11, wherein said single valve closing member has a lozenge shape.

16. The valve according to claim 15, wherein said opening of said valve seat has a lozenge shape.

17. The valve according to claim 13, wherein said inlet has a conical inner surface defining a minimum inlet inner diameter.

18. The valve according to claim 13, wherein said outlet has a conical inner surface defining a minimum outlet inner diameter.

19. The valve according to claim 17, wherein said major dimension of said single valve closing member is greater than said minimum inlet inner diameter.

20. The valve according to claim 18, wherein said major dimension of said single valve closing member is greater than said minimum outlet inner diameter.

21. The valve according to claim 17, wherein said minor dimension of said single valve closing member is smaller than said minimum inlet inner diameter.

22. The valve according to claim 18, wherein said minor dimension of said single valve closing member is smaller than said minimum outlet inner diameter.

23. The valve according to claim 11, wherein said valve comprises a check valve.

24. A method of assembling a valve closing member into a valve having a single piece housing defining an inlet, an outlet and a chamber therebetween, a valve seat being positioned within said chamber, said method comprising:
inserting said valve closing member through one of said inlet and said outlet into said chamber;
mounting said valve closing member within said chamber for movement between a closed position sealingly engaging said valve seat, and an open position out of engagement with said valve seat.

25. The method according to claim 24, comprising inserting said valve closing member through said outlet into said chamber.

26. The method according to claim 24, further comprising pivotably mounting said valve closing member within said chamber.
